(19) United States
(12) Patent Application Publication
(10) Pub. No.: US 2008/0142567 A1
(43) Pub. Date: Jun. 19, 2008

(54) PAIL-PACK FOR WELDING WIRE

(76) Inventors: Yong Chul Kim, Changwon-si (KR); Sung Moo Ha, Changwon-si (KR); Jae Youl Lee, Changwon-si (KR); Hee Young Kim, Changwon-si (KR)

Correspondence Address: THELEN REID BROWN RAYSMAN & STEINER LLP, P.O. BOX 640640, SAN JOSE, CA, 95164-0640, US

(21) Appl. No.: 11/868,527

(22) Filed: Oct. 7, 2007

(30) Foreign Application Priority Data
Dec. 13, 2006 (KR) 10-2006-0126797

(51) Int. Cl. B23K 37/00

(52) U.S. Cl. 228/41

(57) ABSTRACT

Provided is a pail-pack for welding wire, including: an outer cylinder for accommodating a welding wire winding layer; a lower pressure plate having a bottom surface contacting a top portion of the welding wire winding layer to apply pressure to the welding wire winding layer; and an upper pressure plate having a hollow circular shape provided on the lower pressure plate to apply pressure to the lower pressure plate and the welding wire winding layer.

### CROSS-REFERENCE TO RELATED APPLICATION

This application claims the benefit of Korean Patent Application No. 2006-126797, filed on Dec. 13, 2006, which is hereby incorporated by reference as if fully set forth herein.

### BACKGROUND OF THE INVENTION

1. Field of the Invention

The present invention relates to a pail-pack for welding wire, and more particularly, to a pail-pack for welding wire that is convenient to use.

2. Discussion of Related Art

In general, methods of winding welding wire used for automatic and semiautomatic welding apparatuses may be classified into a spool winding method and a pail-pack winding method.

In the case of the pail-back winding method, which is used for winding large-capacity welding wire, the welding wire is wound in a pail-pack container. Here, the structure of the pail-pack container may be largely divided into a single cylindrical structure having only an outer cylinder and a double cylindrical structure having outer and inner cylinders.

In the pail-pack winding method, when welding wire is wound around the inside of an outer cylinder, stress may be applied to the welding wire causing distortion. But, when the welding wire is withdrawn, its resilience enables it to recover from any such distortion.

However, some welding wires are plastically deformed, so that when withdrawn, they cannot completely spring back. As a result, the welding wire becomes kinked and tangled. In order to overcome this drawback, a pressure plate for applying pressure to a welding wire winding layer is provided at an upper end of the wound welding wire.

FIG. 1 is a partially cutaway perspective view of a conventional pail-pack for welding wire, and FIG. 2 is a cross-sectional view of the conventional pail-pack for welding wire shown in FIG. 1.

Referring to FIGS. 1 and 2, a bottom plate 220 is provided at an inner lower end of an outer cylinder 210, and a welding wire winding layer 280 is disposed on a top surface of the bottom plate 220.

When welding wire W is withdrawn from the welding wire winding layer 280, a pressure plate 240 applies pressure to the welding wire winding layer 280 to maintain its position, so that the welding wire W withdraws smoothly and not all at once. Therefore, the welding wire W withdraws along the inside of the pressure plate 240, and thus the welding wire winding layer 280 moves downward under the pressure applied by the pressure plate 240.

However, the foregoing conventional pail-pack for welding wire has the following problems.

First, as soon as distortion-causing stress applied to the welding wire W is removed, the welding wire W springs up toward the inner or outer side of the pressure plate 240 such that wound portions of the welding wire W become kinked and tangled, hindering feeding.

Second, when kinking and tangling of the welding wire W prevents it from being continuously and smoothly fed from a wire feed unit, welding imperfections, for example, skew beads, may occur.

### SUMMARY OF THE INVENTION

The present invention is directed to a pail-pack for welding wire which is convenient to use.

According to an aspect of the invention, a pail-pack for welding wire comprises: an outer cylinder for accommodating a welding wire winding layer; a lower pressure plate having a bottom surface contacting a top portion of the welding wire winding layer to apply pressure to the welding wire winding layer; and an upper pressure plate having a hollow circular shape provided on the lower pressure plate to apply pressure to the lower pressure plate and the welding wire winding layer.

The welding wire withdrawn from the welding wire winding layer may be withdrawn to the outside of the lower pressure plate and then to the inside of the upper pressure plate through a portion where the upper pressure plate overlaps the lower pressure plate.

The outer diameter of the lower pressure plate may be smaller than the outer diameter of the welding wire winding layer, and the inner diameter of the lower pressure plate may be smaller than the inner diameter of the welding wire winding layer.

Also, the outer diameter of the upper pressure plate may be larger than the outer diameter of the lower pressure plate and substantially equal to the outer diameter of the welding wire winding layer, and the inner diameter of the upper pressure plate may be equal to or larger than the inner diameter of the lower pressure plate and smaller than the outer diameter of the lower pressure plate.

The upper and lower pressure plates may be formed of a material having sufficient weight to apply pressure to the welding wire winding layer.

At least one guide band may be provided on an inner surface of the outer cylinder in a lengthwise direction of the outer cylinder and connected to an outer circumferential portion of the upper pressure plate to guide the movement of the upper pressure plate.

A joint may be provided at the outer circumferential portion of the upper pressure plate to allow the guide band to be inserted thereinto.

According to another aspect of the invention, a pail-pack for welding wire comprises: an outer cylinder for accommodating a welding wire winding layer; a lower pressure plate having a bottom surface contacting a top portion of the welding wire winding layer to apply pressure to the welding wire winding layer; an upper pressure plate having a hollow circular shape provided on the lower pressure plate to apply pressure to the lower pressure plate and the welding wire winding layer, the upper pressure plate having at least one joint formed through an outer circumferential surface thereof, and a guide band provided on an inner surface of the outer cylinder in a lengthwise direction of the outer cylinder and forming a predetermined angle in a circumferential direction of the outer cylinder, wherein the guide band is connected through the joint to guide the movement of the upper pressure plate.

The welding wire withdrawn from the welding wire winding layer may be withdrawn to the outside of the lower pressure plate and then to the inside of the upper pressure plate through a portion where the upper pressure plate overlaps the lower pressure plate.

The joint may comprise: an insertion part provided through an outer circumferential surface of the upper pressure plate to have a predetermined length at a predetermined angle and allowing the guide band to be inserted into or drawn out from the upper pressure plate; a withdrawing prevention part connected to an inner end of the insertion part and provided to have a predetermined length in a radius direction of the upper pressure plate; and a guide part connected to one end of the withdrawing prevention part and formed to have a length corresponding to the width of the guide band in a circumferential direction of the upper pressure plate.

The joint may comprise: a cut part provided through an outer circumferential surface of the upper pressure plate to have a predetermined length in a radius direction of the upper pressure plate and allowing the guide band to be inserted into or drawn out from the upper pressure plate; and a guide part connected to an inner end of the cut part and provided to have a length corresponding to the width of the guide band in a circumferential direction of the upper pressure plate.

### BRIEF DESCRIPTION OF THE DRAWINGS

The above and other objects, features and advantages of the present invention will become more apparent to those of ordinary skill in the art by describing in detail exemplary embodiments thereof with reference to the attached drawings in which:

FIG. 1 is a partially cutaway perspective view of a conventional pail-pack for welding wire;

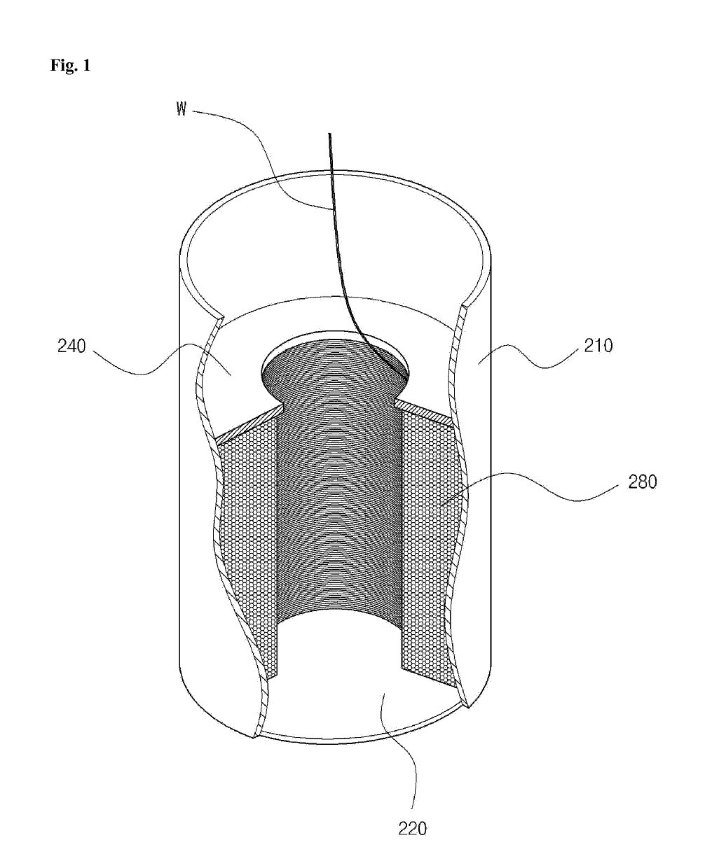

FIG. 2 is a cross-sectional view of the conventional pail-pack for welding wire;

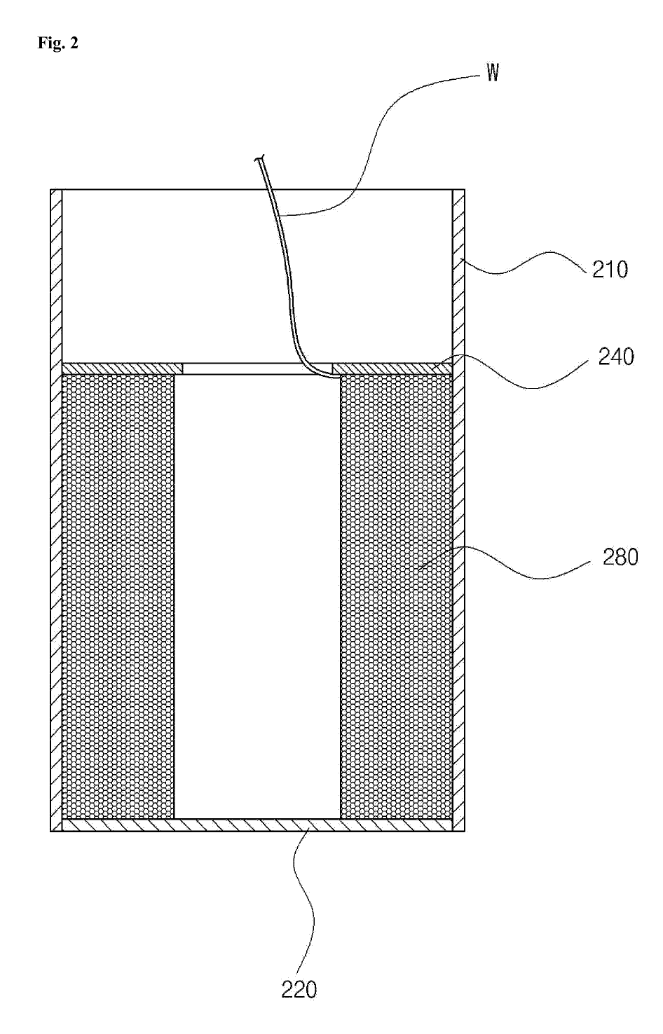

FIG. 3 is an exploded perspective view of a pail-pack for welding wire according to an exemplary embodiment of the present invention;

FIG. 4 is a partially cutaway perspective view of the pail-pack for welding wire according to an exemplary embodiment of the present invention;

FIG. 5 is a cross-sectional view of the pail-pack for welding wire according to an exemplary embodiment of the present invention;

FIG. 6 is a perspective view of an upper pressure plate of the pail-pack for welding wire according to an exemplary embodiment of the present invention;

FIG. 7 is a partially cutaway perspective view of a pail-pack for welding wire according to another exemplary embodiment of the present invention; and

FIG. 8 is a perspective view of an upper pressure plate of the pail-pack for welding wire according to another exemplary embodiment of the present invention.

### DETAILED DESCRIPTION OF EXEMPLARY EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

Hereinafter, a pail-pack for welding wire according to an exemplary embodiment of the present invention will now be described with reference to the accompanying drawings.

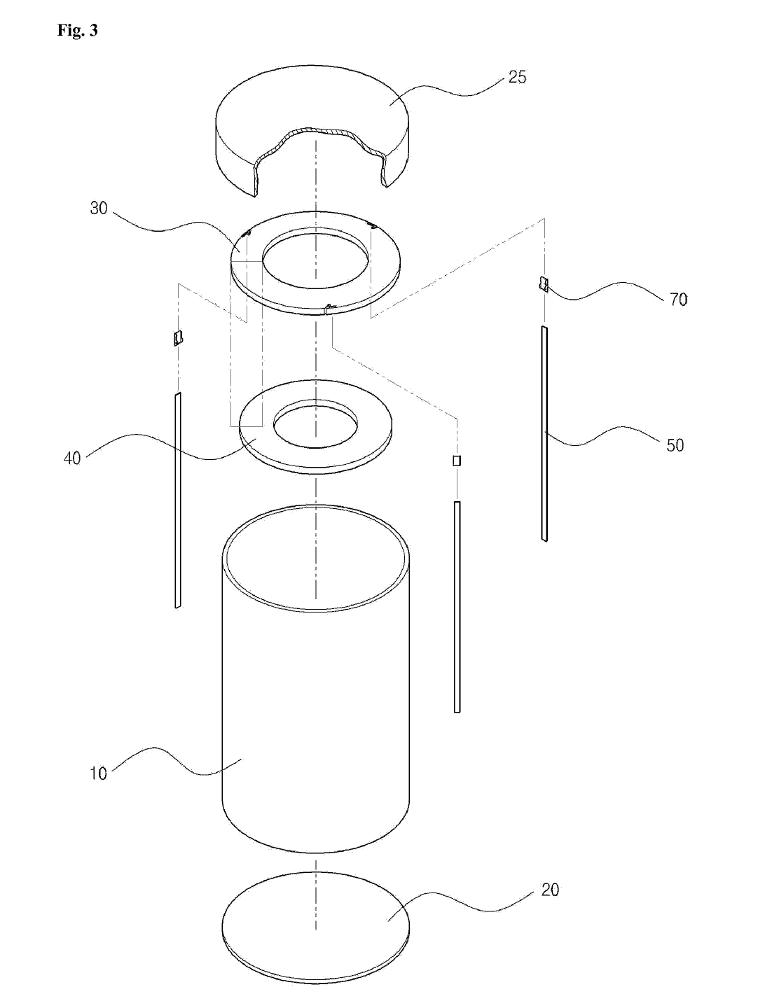

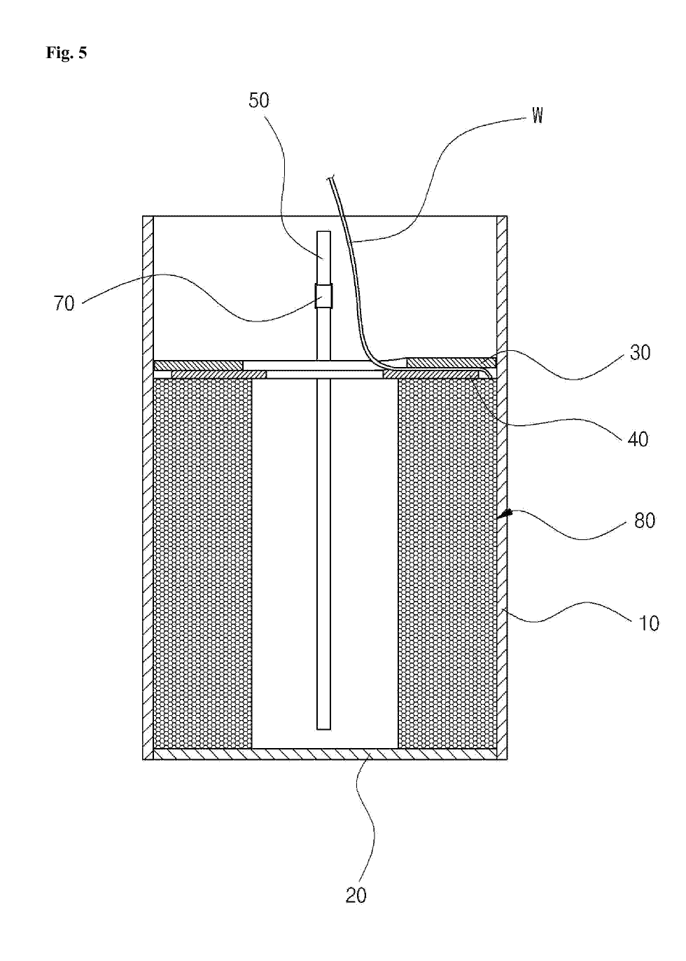

FIGS. 3, 4, and 5 are an exploded perspective view, a partially cutaway perspective view, and a cross-sectional view of a pail-pack for welding wire according to an exemplary embodiment of the present invention, respectively.

Referring to FIGS. 3 through 5, the pail-pack for welding wire according to the exemplary embodiment of the present invention includes an outer cylinder 10, an upper pressure plate 30, and a lower pressure plate 40.

The lower pressure plate 40 and the upper pressure plate 30 are provided at an upper side of a welding wire winding layer 80 accommodated in the outer cylinder 10 to apply pressure to the welding wire winding layer 80. The upper pressure plate 30 may be a hollow plate with a central hole. After welding wire W is withdrawn from the welding wire winding layer 80 to the outside of the lower pressure plate 40, the welding wire W is withdrawn to the inside of the upper pressure plate 30 through a portion where the upper pressure plate 30 overlaps the lower pressure plate 40.

Specifically, a cover 25 is provided on the outer cylinder 10, and a bottom plate 20 is combined with a lower end of the outer cylinder 10. In this case, the bottom plate 20 may be combined with the outer cylinder 10 in various manners. Also, an inner cylinder (not shown) may be selectively provided in the center of the inside of the outer cylinder 10.

Also, the welding wire winding layer 80 is accommodated in the outer cylinder 10 such that the welding wire W is wound in a circumferential direction of the outer cylinder 10. The welding wire W is wound around an inner circumferential surface of the outer cylinder 10 that is eccentrically rotated at high speed. In this case, the welding wire W is repetitively wound such that one end of a loop is brought into contact with the inner circumferential surface of the outer cylinder 10 per rotation cycle.

However, distortion-causing stress may be applied to the welding wire W wound inside the outer cylinder 10 due to its own resilience. Thus, when portions of the welding wire W are withdrawn, they may be plastically deformed, kinked and tangled.

Therefore, the lower pressure plate 40 for applying pressure to the wound welding wire W may be provided on the welding wire winding layer 80 so as to suppress the resilience. Here, the welding wire winding layer 80 refers to a spool of the welding wire W that is wound inside the outer cylinder 10.

In this case, the lower pressure plate 40 may be a hollow circular plate having a predetermined thickness. Also, a bottom surface of the lower pressure plate 40 may be in contact with the top of the welding wire winding layer 80. Furthermore, the inner diameter of the lower pressure plate 40 may be smaller than that of the welding wire winding layer 80.

By maintaining the inner diameter of the lower pressure plate 40 smaller than that of the welding wire winding layer 80, the wound welding wire W can be prevented from being withdrawn to the inside of the lower pressure plate 40. Also, the lower pressure plate 40 can uniformly pressurize the inside of the welding wire winding layer 80.

Also, the lower pressure plate 40 may be formed to have a smaller outer diameter than the welding wire winding layer 80 so that the welding wire W can be withdrawn to the outside of the lower pressure plate 40.

In this case, the outer diameter of the lower pressure plate 40 is not reduced beyond an appropriate range to prevent not the withdrawn welding wire W but the wound welding wire W from being withdrawn to the outside of the lower pressure plate 40.

Also, the upper pressure plate 30, which is a hollow circular plate, may be provided on the lower pressure plate 40. A bottom surface of the upper pressure plate 30 contacts a top surface of the lower pressure plate 40, and the upper pressure plate 30 applies pressure to the lower pressure plate 40 and the welding wire winding layer 80 at the same time.

Here, the outer diameter of the upper pressure plate 30 may be larger than that of the lower pressure plate 40 and approximately equal to that of the welding wire winding layer 80.

As a result, even if a wound loop of the welding wire W is withdrawn to the outside of the lower pressure plate 40, the wound loop of the welding wire W is bound by the upper pressure plate 30 so that it cannot spring to the outside of the upper pressure plate 30. Also, an outer portion of the welding wire winding layer 80 which is not pressed by the lower pressure plate 40 can be pressed by the upper pressure plate 30.

Furthermore, the inner diameter of the upper pressure plate 30 may be equal to or larger than that of the lower pressure plate 40, and smaller than the outer diameter of the lower pressure plate 40. Thus, after the welding wire W is withdrawn to the outside of the lower pressure plate 40, the welding wire W can be guided through the portion where the upper pressure plate 30 overlaps the lower pressure plate 40 and withdrawn through the central hole of the upper pressure plate 30.

That is, the withdrawn welding wire W is partially pressed between the lower pressure plate 40 and the upper pressure plate 30 and slidingly withdrawn. Thus, the withdrawn welding wire W can be fed more efficiently without kinks or tangles.

Meanwhile, the lower pressure plate 40 may be formed of a material having an appropriate hardness in order to prevent deformation. For example, the lower pressure plate 40 may be formed of plastic, synthetic resin, or synthetic rubber. Also, the upper pressure plate 30 may be formed of a material having sufficient weight to apply sufficient pressure to the lower pressure plate 40 and the welding wire winding layer 80.

Furthermore, the upper pressure plate 30 may be formed of a flexible material such that the portion where the upper pressure plate 30 overlaps the lower pressure plate 40 through which the welding wire W is withdrawn can be selectively deformed.

Thus, the upper pressure plate 30 can be prevented from being lifted aslant by the welding wire W passing through the overlapped portion. Also, uniform pressure can be applied to the welding wire winding layer 80.

Further, the upper pressure plate 30 may be formed of a material having an appropriate hardness in order to prevent deformation. For example, the upper pressure plate 30 may be formed of plastic, synthetic resin, or synthetic rubber.

Meanwhile, a guide band 50 may be provided on an inner surface of the outer cylinder 10 in a lengthwise direction of the outer cylinder 10. The guide band 50 may form a predetermined angle with a circumferential direction of the outer cylinder 10.

Here, one end of the guide band 50 may penetrate a portion of the top of the outer cylinder 10, and the other end of the guide band 50 may penetrate a portion of the bottom of the outer cylinder 10 to be fixed.

Of course, both ends of the guide band 50 may be respectively adhered to the top and bottom of the outer cylinder 10 or fixed to the top and bottom of the outer cylinder 10 by coupling members. Also, the guide band 50 may be combined with a joint 60 prepared at an outer circumferential portion of the upper pressure plate 30.

As described above, when the guide band 50 is combined with the joint 60, the upper pressure plate 30 may be bound to prevent rotation. Also, when the welding wire W is withdrawn, the height of the welding wire winding layer W is reduced, so that the upper pressure plate 30 can be guided by the guide band 50 and moved downward smoothly.

Furthermore, a loop of the welding wire W, which protrudes to the outside of the upper pressure plate 30, is bound by the guide band 50 and is neither kinked nor tangled.

The guide band 50 may be formed of a resin having a sufficient intensity to bind the joint 60, prevent rotation of the upper pressure plate 30, and guide the movement of the upper pressure plate 30.

A buckle 70 is provided at one side of the guide band 50 to tighten the guide band 50 and bring the guide band 50 close to the inner surface of the outer cylinder 10. Also, the buckle 70 can maintain the tension of the guide band 50 so that the guide band 50 can effectively prevent rotation of the upper pressure plate 30 and guide its vertical movement.

Meanwhile, at least one guide band 50 may be provided, and the number of guide bands 50 is not limited in the present invention. For example, at least three guide bands may be provided at predetermined intervals in the circumferential direction of the outer cylinder 10 so as to effectively prevent rotation of the upper pressure plate 30 and efficiently guide its vertical movement.

Of course, the joints 60 may be provided to correspond to the combining positions and the number of the guide bands 50.

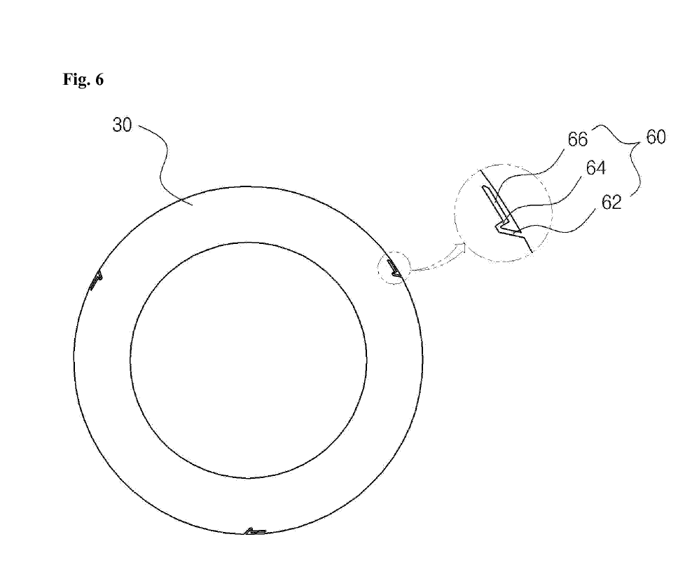

FIG. 6 is a perspective view of the upper pressure plate of the pail-pack for welding wire shown in FIG. 3.

Referring to FIG. 6, the joint 60 provided at the outer circumferential portion of the upper pressure plate 30 includes an insertion part 62, a withdrawing prevention part 64, and a guide part 66.

The insertion part 62 is formed through the outer circumferential surface of the upper pressure plate 30 to have a predetermined length at a predetermined angle.

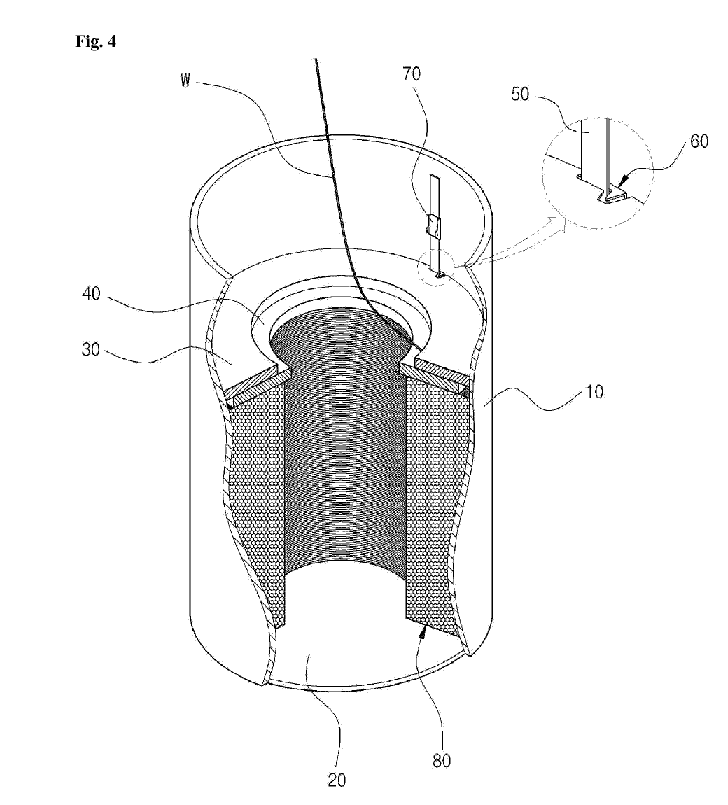

Thus, the insertion part 62 allows the guide band (refer to 50 in FIG. 4) to be inserted into or drawn out from the upper pressure plate 30.

Also, the withdrawing prevention part 64 is connected to an inner end of the insertion part 62 and formed to have a predetermined length in a radius direction of the upper pressure plate 30.

Further, the guide part 66 is connected to one end of the withdrawing prevention part 64 and formed to have a length corresponding to the width of the guide band 50 in a circumferential direction of the upper pressure plate 30.

In this configuration, the guide band 50 can be most closely adhered to the outer cylinder 10, and the binding force of the guide band 50 for the upper pressure plate 30 can be increased.

Here, the withdrawing prevention part 64 is formed at a predetermined angle with each of the insertion part 62 and the guide part 66, thereby preventing the guide band 50 combined with the guide part 66 from being detached from the joint 60.

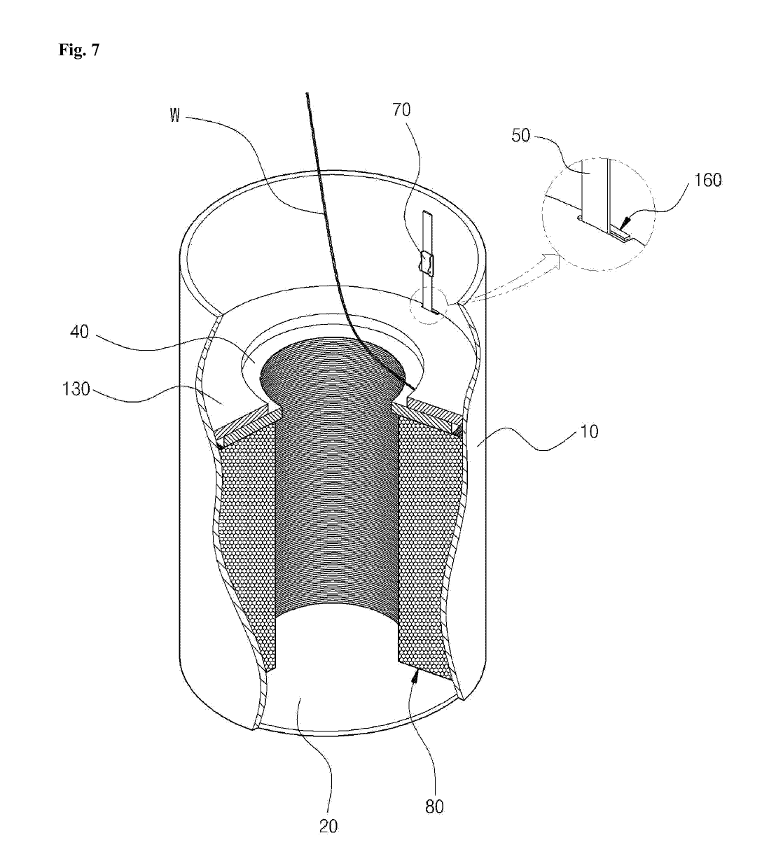

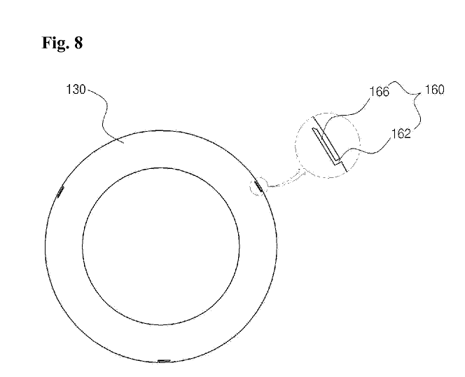

FIG. 7 is a partially cutaway perspective view of a pail-pack for welding wire according to another exemplary embodiment of the present invention, and FIG. 8 is a perspective view of an upper pressure plate of the pail-pack for welding wire shown in FIG. 7.

The pail-pack for welding wire according to another exemplary embodiment of the present invention has nearly the same configuration as the pail-pack for welding wire according to the previous exemplary embodiment of the present invention, except that the structure of a joint is improved. Thus, only the improved joint will be described.

Referring to FIGS. 7 and 8, a joint 160 provided at an outer circumferential portion of an upper pressure plate 130 includes a cut part 162 and a guide part 166.

The cut part 162 is formed through an outer circumferential surface of the upper pressure plate 130 to have a predetermined length extending toward the center of the upper pressure plate 130. Thus, the cut part 162 allows a guide band 50 to be inserted into or drawn out from the upper pressure plate 130.

Also, the guide part 166 is connected to an inner end of the cut part 162 and formed to have a length corresponding to the width of the guide band 50 in a circumferential direction of the upper pressure plate 130.

In this configuration, the guide band 50 can be most closely adhered to the outer cylinder 10, and the binding force of the guide band 50 for the upper pressure plate 130 can be increased.

Here, the cut part 162 is formed at a right angle to the guide part 166, thereby preventing the guide band 50, which is formed through and combined with the guide part 166, from being detached from the joint 160.

As described above, a pail-pack for welding wire has the following effects.

First, since the welding wire is pressed and withdrawn gradually through a space between an upper pressure plate and a lower pressure plate, kinks and tangles caused when too much welding wire is withdrawn all at once can be prevented.

Second, the welding wire is withdrawn to the outside of the lower pressure plate and pressed through the portion where the upper pressure plate overlaps the lower pressure plate, thereby preventing kinks due to the welding wire's resilience and enabling the welding wire to be drawn out in a straight line. As a result, the welding wire can be fed efficiently.

Third, the vertical movement of the upper pressure plate can be efficiently guided along a guide band provided on an inner surface of an outer cylinder in a vertical direction. Also, the guide band can prevent rotation of the upper pressure plate.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A pail-pack for welding wire, comprising:
an outer cylinder for accommodating a welding wire winding layer;
a lower pressure plate having a bottom surface contacting a top portion of the welding wire winding layer to apply pressure to the welding wire winding layer; and
an upper pressure plate having a hollow circular shape provided on the lower pressure plate to apply pressure to the lower pressure plate and the welding wire winding layer.

2. The pail-pack for welding wire according to claim 1, wherein the welding wire withdrawn from the welding wire winding layer is withdrawn to the outside of the lower pressure plate and then to the inside of the upper pressure plate through a portion where the upper pressure plate overlaps the lower pressure plate.

3. The pail-pack for welding wire according to claim 1, wherein the outer diameter of the lower pressure plate is smaller than the outer diameter of the welding wire winding layer, and the inner diameter of the lower pressure plate is smaller than the inner diameter of the welding wire winding layer.

4. The pail-pack for welding wire according to claim 1, wherein the outer diameter of the upper pressure plate is larger than the outer diameter of the lower pressure plate and substantially equal to the outer diameter of the welding wire winding layer, and
the inner diameter of the upper pressure plate is equal to or larger than the inner diameter of the lower pressure plate and smaller than the outer diameter of the lower pressure plate.

5. The pail-pack for welding wire according to claim 1, wherein the upper pressure plate and the lower pressure plate are formed of a material having sufficient weight to apply pressure to the welding wire winding layer.

6. The pail-pack for welding wire according to claim 1, wherein at least one guide band is provided on an inner surface of the outer cylinder in a lengthwise direction of the outer cylinder and connected to an outer circumferential portion of the upper pressure plate to guide the movement of the upper pressure plate.

7. The pail-pack for welding wire according to claim 6, wherein a joint is provided at the outer circumferential portion of the upper pressure plate to allow the guide band to be inserted thereinto.

8. A pail-pack for welding wire, comprising:
an outer cylinder for accommodating a welding wire winding layer;
a lower pressure plate having a bottom surface contacting a top portion of the welding wire winding layer to apply pressure to the welding wire winding layer;
an upper pressure plate having a hollow circular shape provided on the lower pressure plate to apply pressure to the lower pressure plate and the welding wire winding layer, the upper pressure plate having at least one joint formed through an outer circumferential surface thereof, and
a guide band provided on an inner surface of the outer cylinder in a lengthwise direction of the outer cylinder and forming a predetermined angle in a circumferential direction of the outer cylinder, the guide band being connected through the joint to guide the movement of the upper pressure plate.

9. The pail-pack for welding wire according to claim 8, wherein the welding wire withdrawn from the welding wire winding layer is withdrawn to the outside of the lower pressure plate and then to the inside of the upper pressure plate through a portion where the upper pressure plate overlaps the lower pressure plate.

10. The pail-pack for welding wire according to claim 8, wherein the joint comprises:
an insertion part provided through an outer circumferential surface of the upper pressure plate to have a predetermined length at a predetermined angle and allowing the guide band to be inserted into or drawn out from the upper pressure plate;
a withdrawing prevention part connected to an inner end of the insertion part and provided to have a predetermined length in a radius direction of the upper pressure plate; and
a guide part connected to one end of the withdrawing prevention part and formed to have a length corresponding to the width of the guide band in a circumferential direction of the upper pressure plate.

11. The pail-pack for welding wire according to claim 8, wherein the joint comprises:
a cut part provided through an outer circumferential surface of the upper pressure plate to have a predetermined length in a radius direction of the upper pressure plate and allowing the guide band to be inserted into or drawn out from the upper pressure plate; and
a guide part connected to an inner end of the cut part and provided to have a length corresponding to the width of the guide band in a circumferential direction of the upper pressure plate.
